(19) United States
(12) Patent Application Publication
(10) Pub. No.: US 2008/0138481 A1
(43) Pub. Date: Jun. 12, 2008

(54) Methods of reducing reactive carbonyl species

(76) Inventors: Chi-Tang Ho, East Brunswick, NJ (US); Chih-Yu Lo, Somerset, NJ (US); Di Tan, Somerset, NJ (US); Yu Wang, New Brunswick, NJ (US); Slavik Dushenkov, Fort Lee, NJ (US)

Correspondence Address: JONES DAY, 222 EAST 41ST ST, NEW YORK, NY, 10017, US

(21) Appl. No.: 11/636,013

(22) Filed: Dec. 7, 2006

(51) Int. Cl. A23L 3/34

(52) U.S. Cl. 426/532

(57) ABSTRACT

Methods for reducing the concentration of reactive carbonyl species, for example, in thermally processed foods, including beverages, are provided herein.

### 1. TECHNICAL FIELD

This application relates to methods and compositions for reducing concentrations of reactive carbonyl species in food, for instance, in thermally processed food, including beverages. This application also relates to methods for treating or inhibiting a condition in which advanced glycation end products are associated, such as type II diabetes, nephropathy, retinopathy, peripheral neuropathy, arteriosclerosis, Alzheimer's disease, skin photoaging, or a symptom thereof.

### 2. BACKGROUND

Thermal processing is used to preserve and to develop the texture, flavor and color of food. With certain types of food, however, thermal processing accelerates formation of molecules such as glyoxal and methylglyoxal, for instance, that contain reactive carbonyl species. Reactive carbonyl species are key intermediates in the production of advanced glycation endproducts (AGEs), which are implicated in the pathogenesis of hyperglycemia-mediated oxidative stress-related diseases, such as type II diabetes, nephropathy, retinopathy, peripheral neuropathy, arteriosclerosis, Alzheimer's disease and skin photoaging.

AGEs are complex, heterogeneous, sugar derived protein modifications that are formed via the non-enzymatic Maillard or “browning” biochemical reaction between reducing sugars and amine residues on proteins, lipids and nucleic acids. Since sugars can undergo different dehydration, oxidation and fragmentation reactions prior to, and after, attachment to an amine substrate, there are a fair number of different pathways that can lead to AGE formation. See, e.g., Thomalley et al., 1999, Biochem. J. 344:109-116; Rahbar & Figarola, 2002, Curr. Med. Chem.—Imun., Endoc. & Metab. Agents 2:135-161. The formation of reactive carbonyl species is central to all pathways leading to AGE formation.

The classical Maillard pathway is a reaction sequence involving the formation of a Schiff base (aldimine intermediate) that undergoes an Amadori rearrangement to form a fructosamine precursor (termed Amadori product) in the formation of AGEs. Other pathways involve the production of dicarbonyl reactive carbonyl species, for instance, α-oxoaldehydes, without requiring an Amadori product. In this case, production of α-oxoaldehydes is normally a slow process, but becomes significant under certain conditions, for example, in the presence of phosphate ions or at high temperatures. Alpha-oxoaldehydes such as glyoxal, methylglyoxal, and 3-deoxyosones, for instance, react non-enzymatically with protein amino groups to form intermediates that lead to AGEs, such as Nε-carboxymethylysine and Nε-carboxyethylysine.

Methods are sought for reducing reactive carbonyl species associated with the manufacture or consumption of food products.

Citation or identification of any reference in this or any other section of this application shall not be construed as an admission that such reference is available as prior art to the present invention.

### 3. SUMMARY OF THE INVENTION

In one aspect, methods are provided for reducing the concentration of a reactive carbonyl species in a food comprising contacting the food with a scavenging molecule.

In some embodiments, the scavenging molecule is a substantially pure compound.

The scavenging molecule can, for example, be a polyphenol. Exemplary polyphenols include gallic acid, pyrogallol, flavonoids, catechins and theaflavins, and the like.

In some embodiments, the concentration of a reactive carbonyl species is reduced in a thermally processed food. The food can be contacted with the scavenging molecule before, after or during thermally processing the food.

In some embodiments, the methods further comprise packaging the food.

In certain embodiments, the methods provided can be performed, for example, during manufacture of food, or as another example, after manufacture, but prior to or during consumption of manufactured food.

In certain embodiments, the food contacted with the scavenging molecule is a beverage, including, for example, a carbonated soft drink. In certain embodiments, the food is a beverage comprising a phosphate concentration greater than about 0.50 mg/100 mL beverage.

In some embodiments of the methods provided, the reactive carbonyl species is a dicarbonyl compound.

In some embodiments, the amount of scavenging molecule contacting the food will be about 0.01 to about 10 weight percent of the combined weight of food and scavenging molecule.

In another aspect, methods are provided for reducing the concentration of a reactive carbonyl species in a subject, the method comprising administering to the subject an oral delivery form of a composition consisting essentially of a scavenging molecule wherein the composition is administered between from about one hour before to about one hour after a food is consumed by the subject.

A method for treating or inhibiting a hyperglycemia-mediated oxidative stress-mediated condition or disorder in a subject, comprising administering to a subject in need thereof an amount of an isolated green tea catechin, isolated black tea theaflavin, or a mixture thereof, effective to treat or inhibit the hyperglycemia-mediated oxidative stress-mediated condition or disorder.

In some embodiments, the hyperglycemia-mediated oxidative stress-mediated condition or disorder is selected from the group consisting of type II diabetes, nephropathy, retinopathy, peripheral neuropathy, and arteriosclerosis.

In some embodiments, the amount of isolated green tea catechin, black tea theaflavin, or mixture thereof administered to the subject ranges from about 0.1 to about 500 mg/kg of body weight/day.

### 4. BRIEF DESCRIPTION OF THE FIGURES

FIG. 1 provides an exemplary gas chromatography/flame-ionization detection (GC/FID) analysis of oximes formed upon incubating methylglyoxal and O-(2,3,4,5,6-pentafluorobenzyl)-hydroxylamine hydrochloride (PFBOA) for the determination of reactive carbonyl species concentration in a methylglyoxal-containing solution. Peaks labeled I.S. represent an internal standard.

FIG. 2 demonstrates the scavenging efficiencies of various polyphenols on MGO after incubation in a MGO-containing solution for 1 hour at 37° C. The following polyphenols were examined: gallic acid (GA), pyrogallol (PY), epicatechin (EC), epicatechin gallate (ECG), epigallocatechin (EGC), epigallocatechin gallate (EGCG), theaflavin (TF I), theaflavin-mono-gallate (TF2), and theaflavin-di-gallate (TF3). The control (INC) represents incubation in the absence of any polyphenol.

FIG. 3 provides exemplary data demonstrating efficient trapping of MGO by green tea catechins.

FIG. 4 provides exemplary data demonstrating efficient trapping of MGO by black tea theaflavins.

FIG. 5 provides structures of adducts from the reaction of epigallocatechin gallate (EGCG) and methylglyoxal (MGO).

### 5. TERMINOLOGY

Abbreviations used herein are as follows: GO, glyoxal; MGO, methylglyoxal; AGE, advanced glycation end products; GA, gallic acid; PY, pyrogallol; EC; epicatechin; ECG, epicatechin gallate; EGC; epigallocatechin; EGCG, epigallocatechin gallate; TF1, theaflavin; TF2, theaflavin-mono-gallate; TF3, theaflavin-di-gallate; GC/FID, gas chromatography/flame-ionization detection; HPLC-MS; high performance liquid chromatography—mass spectrometry; NMR; nuclear magnetic resonance spectroscopy; PFBOA, O-(2,3,4,5,6-pentafluorobenzyl)-hydroxylamine hydrochloride; O-PFB, O-(2,3,4,5,6-pentafluorobenzyl).

The term “about,” unless otherwise indicated, refers to a value that is no more than 10% above or below the value being modified by the term. For example, the term “about 10 weight percent” means a range of from 9 weight percent to 11 weight percent.

It is contemplated that, the term “composition” is not intended to include a natural source of the composition but can, in certain embodiments, encompass a physically and/or chemically modified or processed form of the natural source. For example, the term “composition” is not intended to encompass the plant or an anatomical part of the plant, however, a powder or a solvent extract of the plant or plant part(s) can be a composition of the invention.

As used herein, “food” means an article meeting the definition of food provided under 21 U.S.C. § 321(f). In some embodiments, a “food” is any substance, whether processed, semi-processed, or raw, which is intended for consumption by animals including humans, but does not include cosmetics, tobacco products or substances used only as pharmaceuticals. As used herein, “food,” is intended to include beverages.

In some embodiments, the food can, for example, be a cooked food, a non-raw food, a manufactured food, a mixture of ingredients (such as, e.g., bread dough) intended for processing into a food product (in this example, bread), a thermally processed food, a beverage, a carbonated beverage, a thermally processed carbonated beverage, and the like.

As used herein, “manufactured food” means a food that has undergone at least one stage in food processing. Examples of food processing include chopping, dicing, mixing, juicing, thermally processing, heating, cooling, cooking including pressure cooking, fermentation, and the like. In certain embodiments, a manufactured food is a food that has been thermally processed.

As used herein, “subject” means an animal, preferably a human.

The term “isolated,” when used in context of a composition that can be obtained from a natural source, refers to a composition that is separated from one or more components from its natural source. Natural sources can be a plant or a natural and unaltered product produced by a plant including bark, bud, cytosol, florescence, flower, fruit, leaf, peel, resin, rind, root, sap, seed, stem, and so forth. Thus, an “isolated” composition is in a form such that the concentration or purity of at least one constituent in the composition is greater than that in its natural source.

As used herein, “treating” and “treatment” mean a reduction or amelioration of the progression, severity and/or duration of a condition or the amelioration of one or more symptoms thereof in a subject.

The terms “inhibiting” and “inhibition,” as used herein in context with methods for “inhibiting” or the “inhibition” of a condition or a symptom thereof, mean the inhibition of the recurrence, onset, or development of the condition or a symptom thereof in a subject.

As used herein, “condition” encompasses conditions, diseases, and disorders.

### 6. DETAILED DESCRIPTION

Provided herein are methods for reducing the concentration of reactive carbonyl species, for example, in food, such as in a thermally processed food, including a thermally processed beverage. Also provided herein are methods for administering a scavenging molecule to a subject in an effective amount to reduce the concentration of reactive carbonyl species in the subject.

In one aspect, methods are provided for reducing the concentration of a reactive carbonyl species in a food comprising contacting the food with a scavenging molecule.

In certain embodiments, the methods provided further comprise thermally processing the food.

The phrase “thermally processing,” as used in the context of “thermally processing a food” means heating a food or food ingredients, for example, pasteurizing, baking, broiling, boiling, microwaving, and so forth. In certain embodiments, the food or mixture of food ingredients, are heated at temperatures of at least about 45° C. In certain embodiments, the food is heated at temperatures between about 95° C. and about 450° C. In certain embodiments, the food is heated at temperatures between about 100° C. and about 350° C. In certain embodiments, the food is heated to temperatures between about 150° C. and about 200° C. In certain embodiments, the food or food ingredients are thermally processed by heating the food of food ingredients to a temperature between about 100° C. and about 205° C. It will be understood that the temperatures provided herein for thermally processing a food are intended to be those for use at about 1 atm, and that the skilled artisan can make adjustments to the temperatures appropriate in view of pressure changes, for example, due to high altitude.

Food ingredients can, for example, be separately processed at elevated temperature prior to the formation of the food product.

The food can, for example, be contacted with the scavenging molecule prior to or while the food is being manufactured, for example, prior to or while thermally processing the food. In some embodiments, the food can be contacted with the scavenging molecule after thermally processing the food.

In certain embodiments, the food or food ingredients are those of liquid and/or particulate foods such as, for instance, milk and milk products, soups, sauces, fruit juices, and other beverages, where, for example, thermal processing is used to preserve the food and food ingredients and/or as a means of developing texture, flavor and color.

In some embodiments of the methods provided, the methods further comprise packaging the food.

By the phrase “reactive carbonyl species,” it is meant a molecule comprising a carbonyl group (C═O), wherein the carbonyl group is susceptible to attack by a nucleophile. Those of skill in the art will understand that nucleophiles can include, for instance, the lysine amino groups of proteins, or the phenolic rings of flavonoid compounds. In certain embodiments, a “reactive carbonyl species” is a molecule comprising a carbonyl group wherein the carbonyl group is susceptible to attack by a nucleophile when in solution under conditions of about pH 7.4 and about 37° C.

In certain embodiments, the reactive carbonyl species is a dicarbonyl compound. For instance, in certain embodiments the reactive carbonyl species is a dicarbonyl compound of the formula (I): R¹—(C═O)—(CH₂)ₙ—C═O)R², where R¹ and R² independently are hydrogen or an aliphatic group, and the subscript n is 0 or 1. In certain embodiments, both R¹ and R² are hydrogen. In certain embodiments, both R¹ and R² are a substituted or unsubstituted aliphatic group. In certain embodiments, R¹ is a substituted or unsubstituted aliphatic group, and R² is hydrogen.

In certain embodiments of the reactive carbonyl species of formula I, subscript n is 0, and R² is hydrogen, such as, for example, the α-oxoaldehyde compounds. Exemplary α-oxoaldehydes include, for example, glyoxal, methylglyoxal, hydroxypyruvaldehyde, erythrosone, 3-deoxyerythrosone, ribosone, 3-deoxyribosone, glycosone, 1-deoxyglycosone, 3-deoxyglycosone, 3,4-dideoxyglucosone-3-ene, among others.

In particular embodiments, the reactive carbonyl species are selected from the group of α-oxoaldehydes consisting of glyoxal, methylglyoxal and 3-deoxyglucosone.

By “scavenging molecule,” it is meant a nucleophile or molecule comprising a nucleophilic moiety that reduces the concentration of reactive carbonyl species in a population of reactive carbonyl species. Without intending to be bound by any particular mechanism or theory, the scavenging molecule is believed to form an adduct with the reactive carbonyl species through nucleophilic attack at the carbonyl center of the reactive carbonyl species, thereby reducing the concentration of the reactive carbonyl species.

In certain embodiments, the scavenging molecule is a molecule comprising one or functional groups selected from the group consisting of a thiol, phenol, hydroxyl and amino group.

In certain embodiments, the scavenging molecule consists essentially of a substantially pure compound. By “substantially pure compound,” it is meant a compound that is isolated from a natural source, or synthesized in vitro, to be at least 75% pure by weight. In certain embodiments, the purity of a “substantially pure compound” is at least 85%, at least 90%, at least 95%, at least 99% or 100% pure.

In certain embodiments, two, three, four, five, six, seven, eight, or more scavenging molecules are used together or sequentially to contact the food in the methods provided.

In certain embodiments, the scavenging molecule is a polyphenol. As used herein, “polyphenol” means a compound characterized by having two or more phenol groups per molecule. Polyphenols include, for example, gallic acid, pyrogallol, and the flavonoids, defined below.

In particular embodiments where the scavenging molecule is a polyphenol, the polyphenol is gallic acid or pyrogallol.

In some embodiments, the scavenging molecule is a flavonoid. As used herein, “flavonoid” means a compound characterized by the presence of a 2-phenylbenzopyrone structure, and which collectively comprises flavonols, flavanols, flavones, flavanones, isoflavones and anthocyanidins. Flavonols include, for example, quercetin, kaempferol, rutin, myricetin and isorhamnetin. Flavanols include, for example, the catechins and the theaflavins, defined below. Flavones include, for example, luteolin and apigenin. Flavanones include, for example, hesperetin, naringenin, and eriodictyol. Isoflavones include, for example, genistein, daidzein and glycitein. Anthocyanidins include, for example, cyanidin, delphinidin, malvidin, pelargonidin, peonidin, petunidin.

In particular embodiments, the scavenging molecule is a flavonoid selected from the group consisting of quercitin, kaempferol, rutin, a green tea catechin and a black tea theaflavin.

As used herein, “catechin” means a family of compounds characterized by a 3-hydroxyl-2-phenylbenzopyrone structure. Catechins include, for example, epicatechin, epicatechin gallate, epigallocatechin, and epigallocatechin gallate.

As used herein, “theaflavin” means a family of compounds characterized by two catechin moieties dimerized through a hydroxy-substituted benzotropolone ring. Theaflavins include, for example, theaflavin, theaflavin-mono-gallate and theaflavin-di-gallate.

In certain embodiments, the scavenging molecule is a green tea catechin selected from the group consisting of epicatechin, epicatechin gallate, epigallocatechin, and epigallocatechin gallate (EGCG).

In certain embodiments, the scavenging molecule is a black tea theaflavin selected from the group consisting of theaflavin, theaflavin-mono-gallate and theaflavin-di-gallate.

Polyphenols that can be used as scavenging molecules in the present invention are compounds well known to those skilled in the art and are commercially available from commercial vendors, for example, Sigma-Aldrich Chemical Co. (St. Louis, Mo.). Plant extracts containing polyphenols are also suitable for use in the present invention. For example, rutin, evening primrose, onion, and citrus species contain quercetin and naringenin, soy contains daidzin and genistein and green tea varieties contain EGCG and kaempferol. Flavonoid-containing plant extracts are commercially available. Polyphenols and flavonoids may also be extracted from native plants using conventional methods.

The extraction of flavonoids from green and black tea can be carried out by a conventional method such as by stirring extraction. An exemplary extraction method for catechins from green tea is that disclosed in U.S. Pat. Nos. 5,989,557 and 6,096,359. An exemplary extraction method for theaflavins from fermented or semi-fermented tea is that disclosed in U.S. Pat. No. 6,113,965.

Sources of green tea catechins include, for example, sencha (middle-grade green tea), gyokuro (shaded green tea) or tencha (powdered tea) prepared from green tea leaves obtained from the Genus Camellia, for example, C. sinensis, C. assamica, the Yabukita variety, or a hybrid thereof. Sources of black tea theaflavins include semi-fermented tea, which is generally called oolong tea, include tekkannon (Tieguangin), irotane, ougonkei (Huangjigui) or buigancha (Wuyiyaucha), and fermented tea include Darjeeling, Assam or Sri Lanka which are collectively called “black tea”.

In certain embodiments of the methods provided, the concentration of the reactive carbonyl species in the food is reduced by about 25% to about 100% after contact with the scavenging molecule. In some embodiments, at least about 5%, at least about 10%, at least about 15%, at least about 20%, at least about 25%, at least about 30%, at least about 40%, at least about 50%, at least about 60%, at least about 70%, at least about 75%, at least about 80%, or at least about 90% of the reactive carbonyl species are eliminated after contact with the scavenging molecule.

In certain embodiments of the methods provided, the amount of scavenging molecule contacting the reactive carbonyl species comprises from about 0.001 weight percent to about 10 weight percent of the food and scavenging molecule combination. In some embodiments, the amount of the scavenging molecule is between about 0.01 weight percent to about 10 weight percent of the combined food and scavenging molecule. In some embodiments, the amount of the scavenging molecule is between about 0.05 weight percent to about 5.0 weight percent of the combined food and scavenging molecule. In some embodiments, the weight percentage of the scavenging molecule is about 0.05, about 0.1, about 0.15, about 0.5, about 1.0, about 2.5, or about 5.0 weight percent of the combined food and scavenging molecule.

In certain embodiments of the methods provided, the food is a beverage. The beverage can, for example, be packaged in conventional ways such as in cans, bottles, cartons or other sealed packages. In particular embodiments, the beverage is packaged in a bottle or can. The beverage can, for example, be in a liquid form or solid, for instance, frozen.

The beverage can, for example, be a carbonated or uncarbonated soft drink, soda, juice, lemonade, tea, isotonic drink, health drink, energy drink, fruit or vegetable drink. In particular embodiments, the beverage is a still fruit drink, a carbonated soft drink, health drink or an energy drink.

In some embodiments, the pH of the beverage ranges from about 2.0 to about 6.0. In certain embodiments, the pH of the beverage ranges from about 2.0 to about 4.0. In certain embodiments, the pH of the beverage ranges from about 4.0 to about 6.0.

In particular embodiments, the beverage comprises a phosphate ion concentration that is greater than about 0.50 mg per 100 mL beverage and less than about 5.00 mg per 100 mL beverage.

In particular embodiments, the beverage comprises a concentration of the reactive carbonyl species that is greater than about 3 μg/100 mL beverage prior to being contacted with the scavenging molecule.

In some embodiments of the methods provided for reducing reactive carbonyl species concentrations in a beverage, the methods comprise contacting a reactive carbonyl species in a beverage with a scavenging molecule, wherein the scavenging molecule is a substantially pure compound. In some embodiments the scavenging molecule is selected from the group consisting of green tea catechin, black tea theaflavin and a mixture of green tea catechin and black tea theaflavin.

In the methods provided for reducing a reactive carbonyl species in a food, the reactive carbonyl species can be contacted with a scavenging molecule at any time, for example, before, during or after the manufacture of the food, or for instance, before, during, or after consumption of the food by a subject.

The methods provided for reducing a reactive carbonyl species in a food generally do not encompass manufacturing, e.g., thermally processing, a food where the only source of the scavenging molecule comes from the food being manufactured. Typically, the scavenging molecule is added to the food. In certain embodiments, the scavenging molecule fortifies one or more scavenging molecules found in the food. In certain embodiments, the food contacted with a given scavenging molecule lacks detectable quantities of the scavenging molecule prior to contact with the scavenging molecule.

In one aspect, a product is provided, wherein the product is produced by a method as described herein.

In another aspect, methods are provided for reducing the concentration of a reactive carbonyl species in a subject. In particular, methods are provided comprising administering to a subject an oral delivery form of a composition comprising a scavenging molecule wherein the composition is administered between about one hour before to about one hour after a food is consumed by the subject. In certain embodiments, the composition administered consists essentially of the scavenging molecule. Oral delivery forms are discussed below.

In yet another aspect, methods are provided for treating or inhibiting a hyperglycemia-mediated oxidative stress-related condition or disorder, or symptom thereof, in a subject. For example, in some embodiments, the methods provided comprise administering an amount of a composition consisting essentially of a scavenging molecule to a subject in need thereof in an amount effective to treat or inhibit the hyperglycemia-mediated oxidative stress-related condition or disorder, or symptom thereof.

“Hyperglycemia-mediated oxidative stress” is a condition characterized by the generation of free radicals, particularly reactive oxygen species, caused by the formation of AGEs, that leads to or facilitates the advancement of chronic neurodegenerative diseases, such as Alzheimer's disease, skin photoaging, and other degenerative diseases characteristic of the aging process, type II diabetes, nephropathy, retinopathy, peripheral neuropathy, and arteriosclerosis, among others. The phrase “hyperglycemia-mediated oxidative stress-related conditions and diseases,” as used herein, is meant to include such diseases or conditions. In certain embodiments, a “hyperglycemia-mediated oxidative stress-related condition or disease” is type II diabetes, nephropathy, retinopathy, peripheral neuropathy, or arteriosclerosis.

In certain embodiments, the scavenging molecule for use in the methods for treating or inhibiting a hyperglycemia-mediated oxidative stress-related condition or disease is an isolated green tea catechin, black tea theaflavin, or mixture thereof. In some embodiments, the green tea catechin is selected from the group consisting of epicatechin, epicatechin gallate, epigallocatechin, and epigallocatechin gallate. In certain embodiments, the black tea theaflavin is selected from the group consisting of theaflavin, theaflavin-mono-gallate and theaflavin-di-gallate.

As used herein, “effective amount,” as used herein, refers to the amount of scavenging molecule that is sufficient to produce a desirable or beneficial effect when administered to a subject. In some embodiments, an “effective amount” of scavenging molecule reduces or ameliorates the severity or duration of a hyperglycemia-mediated oxidative stress disease, condition, or symptom thereof, or inhibits the onset or advancement of a hyperglycemia-mediated oxidative stress disease, condition, or symptom thereof. In certain embodiments, an effective amount refers to the amount of scavenging molecule that reduces the concentration of reactive carbonyl species, glycated protein or AGEs by at least 5%, preferably at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, or at least 99%, relative to a control or placebo.

The amount of scavenging molecule that will be effective in conjunction with a particular method will vary, e.g., with the nature and severity of the disorder and the route by which the active ingredient is administered. The frequency and dosage will also vary according to factors specific for each subject, such as age, body, weight, response, and the past medical history of the subject. Effective doses may be extrapolated from dose-response curves derived from in vitro or animal model test systems. Suitable regiments can be selected by one skilled in the art by considering such factors and by following, for example, dosages reported in the literature and recommended in the Physician's Desk Reference (58th ed., 2004).

Exemplary doses include milligram or microgram amounts of the scavenging molecule per kilogram of subject or sample weight per day (e.g., about 1 μg/kg of body weight/day to about 500 milligrams per kilogram, about 100 micrograms per kilogram to about 250 milligrams per kilogram, or about 1 milligram per kilogram to about 100 milligrams per kilogram). For instance, in certain embodiments where the scavenging molecule is an isolated green tea catechin, black tea theaflavin, or mixture thereof, doses can, for example, range from about 0.1 to about 500 mg/kg of body weight/day.

In general, the recommended daily dose range of a scavenging molecule, for instance, isolated green tea catechin, black tea theaflavin, or mixture thereof, for the conditions described herein lie within the range of from about 0.1 mg to about 500 mg per day, given as a single once-a-day dose preferably as divided doses throughout a day. In one embodiment, the daily dose is administered twice daily in equally divided doses. Specifically, a daily dose range should be from about 5 mg to about 500 mg per day, more specifically, between about 10 mg and about 200 mg per day. In managing the subject, the therapy should be initiated at a lower dose, perhaps about 1 mg to about 25 mg, and increased if necessary up to about 200 mg to about 1000 mg per day as either a single dose or divided doses, depending on the subject's global response. It may be necessary to use dosages of the active ingredient outside the ranges disclosed herein in some cases, as will be apparent to those of ordinary skill in the art.

In the methods provided, a scavenging molecule can, for example, be administered by any route suitable to deliver an effective amount to the subject. In some embodiments, the scavenging molecule is deliver by intravenous injection, by topical application, or by oral delivery.

In preparing the scavenging molecule for oral delivery in the methods provided, any of the usual nutraceutical and/or pharmaceutical carriers may be employed. For oral liquid preparations (e.g., suspensions, elixirs, and solutions), carriers containing water, oils, alcohols, flavoring agents, preservatives, coloring agents and the like may be used. Carriers such as starches, sugars, diluents, granulating agents, lubricants, binders, disintegrating agents, and the like may be used to prepare oral solids (e.g., powders, gelatin capsules, pills, and tablets). Lozenges, chewable tablets and controlled release forms may also be used. If desired, tablets may be sugar coated or enteric coated by standard techniques. Examples of additional inactive components which provide for easier oral administration include but are not limited to beeswax, lecithin, gelatin, purified water, and glycerin. In certain embodiments, the scavenging molecule can be administered, for example, as food additive, including beverage additive. In certain embodiments of the methods provided, the scavenging molecule is orally administered in the form selected from the group consisting of a concentrate, liquid, dried powder, soft gel, solution, suspension, emulsion, capsule, pellet, pill, food additive, and beverage additive.

### 7. EXAMPLES

The following examples are intended only to further illustrate the invention and are not intended to limit the scope of the invention as defined by the claims.

### 7.1 Example 1

### Scavenging of Reactive Carbonyl Species by Polyphenols

This example demonstrates that polyphenols, as a class of compounds, are effective scavengers of reactive carbonyl species under physiologically relevant conditions. In particular, concentrations of a reactive carbonyl species in methylglyoxal (MGO), a dicarbonyl molecule, are demonstrated to be reduced by contact with polyphenols at pH 7.4 and 37° C.

### 7.1.1 Materials

Methylglyoxal (MGO), obtained as 40 wt. % solution in water, O-(2,3,4,5,6-pentafluorobenzyl)-hydroxylamine hydrochloride (PFBOA), and phosphate buffered saline (0.138 M NaCl; 0.0027 M KCl, pH 7.4) were purchased from Sigma-Aldrich Chemical Co. (St. Louis, Mo.). 2-Chlorobezaldehyde was purchased from Fluka (Germany).

### 7.1.2 Measurement of Reactive Carbonyl Species Concentrations

Quantities of MGO were determined by addition of PFBOA to MGO-containing solutions and analyzing for the presence of methylglyoxal O-PFB oxime derivatives using gas chromatography/flame-ionization detection (GC/FID). PFBOA was prepared in a 32 mM stock solution in phosphate buffered saline, pH 7.4. After adding appropriate amounts of PFBOA and of 2-chlorobezaldehyde (an internal standard) to the MGO samples, the vials were shaken vigorously by vortexing for 5 seconds, and incubated for 15 minutes on a laboratory shaker at 37° C. The oximes formed by the derivatization reaction were extracted by methylene chloride, which were concentrated under gentle nitrogen gas.

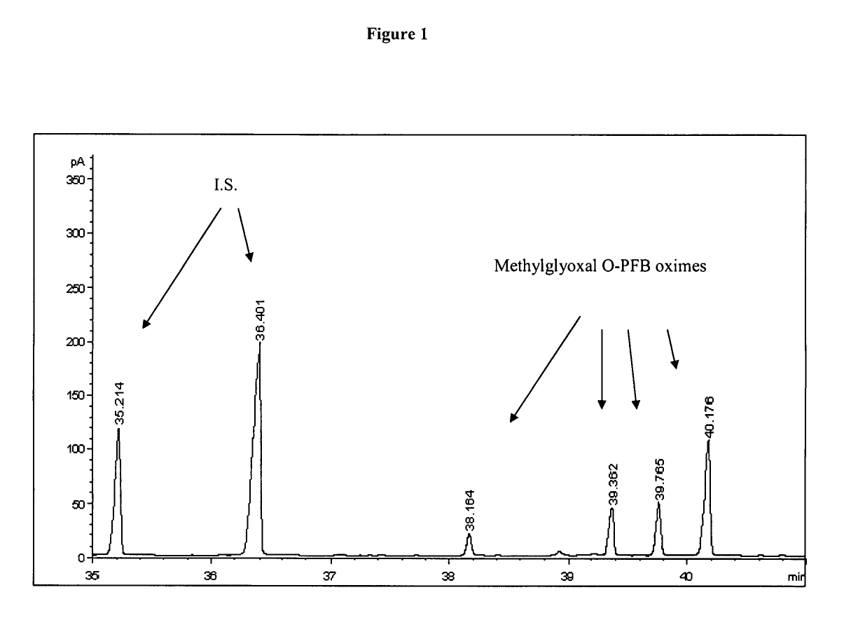

FIG. 1 provides an exemplary GC/FID analysis following PFBOA derivatization of methylglyoxal. Four MGO-O-PFB oxime peaks are seen in the figure at the following retention times: 38.164, 39.362, 39.765, and 40.176. Concentrations of methylglyoxal in solutions described in the following examples were determined by PFBOA derivatization and GC/FID monitoring the intensities of these four peaks. Peaks labeled “I.S.” represent those formed by the internal standard.

In the examples described below, where MGO quatitities are determined in solutions following incubation, the initial amount of MGO, that is, the MGO determined at the zero time point, is taken as being 100%.

### 7.1.3 Methylglyoxal Scavenging by Different Polyphenols

Solutions of 2.0 mM MGO and 5.3 mM polyphenol were freshly prepared in phosphate buffered saline, pH 7.4. 8.0 mL of the MGO solution and either 1 ml of the polyphenol solution or 1 ml of a phosphate buffer solution (the control) were mixed in individual vials, and the vials capped and stirred vigorously for 5 seconds. The vials were incubated and shaken at 40 rpm for 1 hour in a 37° C. water bath. The reduced concentrations of MGO remaining in the vials post-incubation with the polyphenol were then measured as described above. All samples were in triplicate.

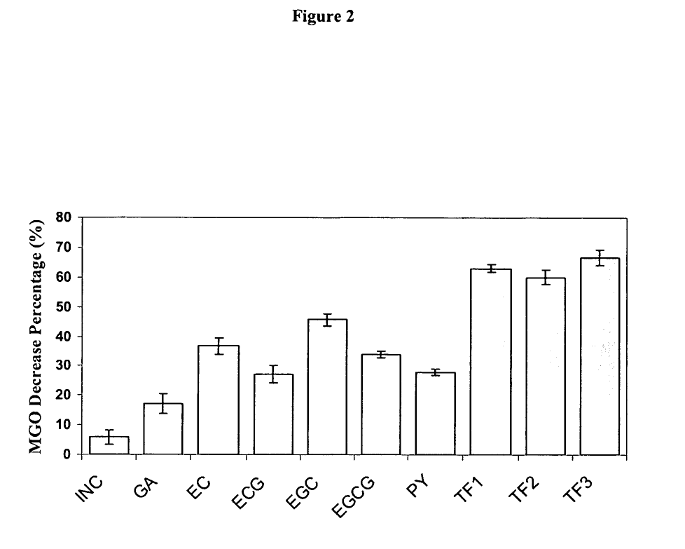

FIG. 2 demonstrates the scavenging efficiencies of various polyphenols on MGO. Scavenging efficiency is defined as the percentage decrease in MGO concentration observed post-incubation with polyphenol or buffer alone (“INC”), as measured from decreases in the intensities of the four oxime peaks in the GC/FID spectrum, when compared to the initial MGO concentration. The following polyphenols were examined: gallic acid (GA), pyrogallol (PY), epicatechin (EC), epicatechin gallate (ECG), epigallocatechin (EGC), epigallocatechin gallate (EGCG), theaflavin (TF1), theaflavin-mono-gallate (TF2), and theaflavin-di-gallate (TF3).

These results demonstrate that polyphenols are generally effective in reducing a reactive carbonyl species in solution under physiological relevant conditions.

### 7.1.4 Time Course of Scavenging Efficiency

Solutions of 2.0 mM MGO and 5.3 mM polyphenol were freshly prepared in phosphate buffered saline, pH 7.4. 2.67 mL of the MGO solution and 1 ml of the polyphenol solution were mixed in individual vials, and the vials capped and stirred vigorously for 5 seconds. The vials were then incubated and shaken at 40 rpm in a 37° C. water bath for 5, 10, 20, 30 or 40 minutes. At each time point, a subset of the vials were removed to an ice/salt bath, and the concentrations of the MGO in the vials were measured using PFBOA derivatization and GC/FID as described above.

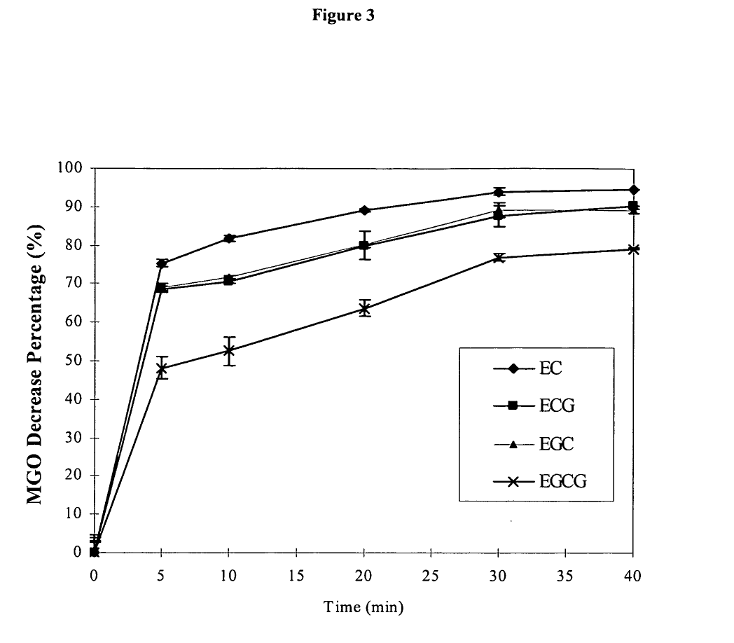

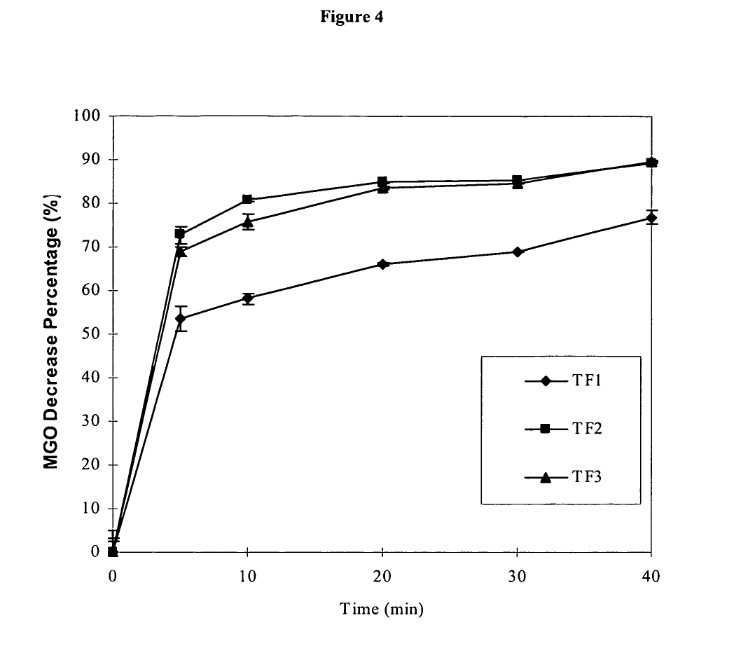

FIG. 3 provides a time course study demonstrating efficient trapping of MGO by green tea catechins. FIG. 4 provides a time course study demonstrating efficient trapping of MGO by black tea theaflavins. Taken together, these results demonstrate that green tea catechins and black tea theaflavins reduce the concentration of MGO in a composition by at least about 70% over a period of 40 minutes.

Thus, polyphenols, for instance, green tea catechins and black tea theaflavins, are efficient scavengers of reactive carbonyl species, such as, for example, MGO.

### 7.2 Example 2

### Adduct formation

The data provided in this example indicate that reactive carbonyl species form adducts with polyphenol scavenging molecules. The green tea polyphenol epigallocatechin gallate (EGCG) was used in these studies.

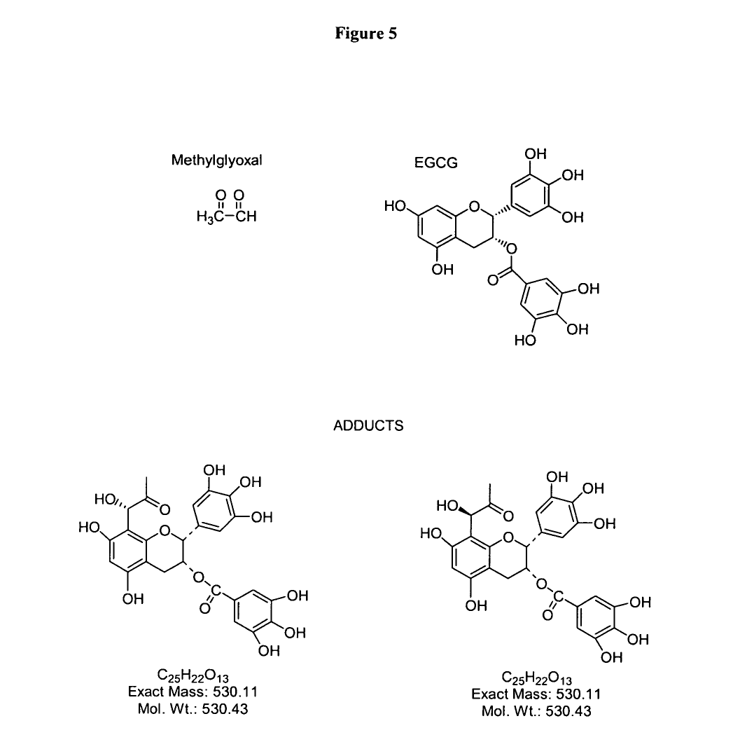

To identify the products of a reaction between MGO and EGCG, 4 mL of 0.11 M EGCG in PBS and 0.5 mL of 0.55 M MGO in PBS were added to four vials, which were then incubated in 37° C. water bath for 20 minutes. The EGCG/MGO solutions were combined and dried under vacuum. The dry powder was dissolved in 95% ethanol and the solution was applied to a Sephadex LH-20 column using 95% ethanol as the eluent. The fractions were collected by a fraction collector. The purity of each fraction was checked by thin-layer chromatography. A highly pure product was collected and identified by mass spectrometry and NMR spectroscopy to be composed of stereoisomers as shown in FIG. 5. Positive electron spray ionization (ESI)-MS m/z with (MH⁺-18) at m/z 513 was detected.

These results indicate that polyphenols, for example EGCG, form covalent adducts with the reactive carbonyl species of MGO.

Another in vitro redox system study was performed in which reactive carbonyl species GO or MGO were reacted with EGCG in phosphate buffered saline solution at 37° C. By comparing the LC/MS (+) and (−), the products of the addition of one or two molecules of GOs to EGCG molecule were found in the GO/EGCG system. The addition of one or two molecules of MGOs to EGCG, or one to four molecules of MGOs to EGCG dimer were found in the MG/EGCG system.

### 7.3 Example 3

### Measurement of GO and MGO in Carbonated Beverages

This example describes the results of an assay for glyoxal (GO) and methylglyoxal (MGO) reactive carbonyl species in commercial carbonated beverages.

Eight commercial and national brand carbonated can beverages were examined. The MGO and GO in carbonated beverages were derivatized by 2,3-diaminobenzene, and the resulting solution was extracted by methylene chloride. After concentration with nitrogen, the MGO and GO derivatives were separated and quantified by gas chromatography. These carbonated can beverages were found to contain significantly high levels of MGO concentrations (ranging from 56 to 370 μg/100 mL) and, in some cases, significantly high levels of GO concentrations (ranging from 9 to 152 μg/100 mL) as indicated in Table 1.

TABLE 1
Levels of glyoxal and methylglyoxal in commercial
carbonated beverages

| Commercial | | |
|---|---|---|
| carbonated | Glyoxal (GO) | Methylglyoxal (MGO) |
| beverage | (μg/100 mL beverage) | (μg/100 mL beverage) |
| #1 | 52 | 246 |
| #2 | 30 | 79 |
| #3 | 9 | 245 |
| #4 | 18 | 93 |
| #5 | 15 | 56 |
| #6 | 27 | 370 |
| #7 | 152 | 270 |
| #8 | 18 | 102 |

### 7.4 Example 4

### Reducing Reactive Carbonyl Species in Beverages

This example demonstrates that storing carbonated high fructose corn syrup solutions in the presence of green tea polyphenols significantly decreases methylglyoxal concentrations in the solutions.

A carbonated high fructose corn syrup solution was prepared that had characteristics for a standard commercially available beverage. Batches (9 kg) of the carbonated high fructose corn syrup solution were prepared to contain 0.5%, 0.1%, 0.15% green tea powder extract or prepared without green tea extract (control). Ingredients, in amounts shown in Table 2, were weighed and blended well in 5 gallon carboys, and the solutions filtered using a ECONOLINE filter (Item No. EFC 10; Royal Paper Products, Coatesville, Pa.), and stored at 40° F. overnight. The solutions were transferred into Cornelius kegs, charged with CO₂ and held in ice water during the filling process. Filling was accomplished with a MELVICO counter pressure filler. The control and tea-containing solutions were filled into 187 ml clear glass bottles and capped with crimp caps. The bottles holding the control and tea-containing solutions were kept at room temperature for one, two or three weeks after which the solutions were tested for concentration of MGO.

TABLE 2
Ingredients in the Preparation of Carbonated High
Fructose Corn Syrup Solutions

| Component | Source | Control % | % | % | % |
|---|---|---|---|---|---|
| Spring Water | Crystal Rock | 86.31 | 86.27 | 86.18 | 86.22 |
| High fructose | Sweeteners | 13.62 | 13.61 | 13.60 | 13.61 |
| corn syrup, | Plus, Inc. | | | | |
| 55% | | | | | |
| Phosphoric | Astaris | 0.07 | 0.07 | 0.07 | 0.07 |
| acid, 75% | | | | | |
| Tea Extract | WellGen, Inc. | 0.00 | 0.05 | 0.15 | 0.10 |
| | | 100.00 | 100.00 | 100.00 | 100.00 |

Characteristics of the control and 0.05%, 0.1% and 0.15% green tea-containing extracts are shown in Table 3. These chemical/physical results are considered acceptable for a standard carbonated beverage. The titratable acidity (TA) was found to increase with increasing amounts of tea extract in the solutions. Filtration facilitated maintenance of CO₂ levels in the solutions.

TABLE 3
Characteristics of the Carbonated High
Fructose Corn Syrup Solutions

| | | | | TA* | |
|---|---|---|---|---|---|
| (Standard | | Brix | pH | (target | CO₂ |
| Beverage) | | (10.6 ± 0.2%) | (2.5 ± 0.2) | variable) | (3.8 ± 0.2) |
| Control | | 10.6 | 2.51 | 9.98 | 3.8 |
| Green Tea | 0.15% | 10.7 | 2.51 | 13.31 | 3.9 |
| | 0.10% | 10.7 | 2.48 | 12.08 | 3.9 |
| | 0.05% | 10.6 | 2.53 | 11.16 | 3.9 |

*Titratable Acidity, ml 0.1N NaOH per 100 ml, to pH 8.3.

To assess MGO concentrations in the solutions, the derivatizing reagent 1,2-diaminobenzene was added to the solutions, and the product was analyzed by gas chromatography (GC). The concentration of 1,2-diaminobenzene was 0.02 mmole/mL. After the derivatization reaction, 0.4 mmole/mL acetaldehyde was used to react with remaining diaminobenzene after derivatization. 5 μmole/mL hexane-2,3-dione was used as an internal standard in GC analysis. For each sample, 4 mL sample solution, 1 mL 1,2-diaminobenzene and 0.5 mL internal standard were mixed together and put into a 60° C. water bath for 15 min to derivatize MGO. Then 1 mL acetaldehyde was added and the sample was left to incubate in a 60° C. water bath for 15 min. The mixture was cooled by ice bath and extracted twice with 4 mL methylene chloride. The organic phase was concentrated by nitrogen gas and 1 μL of it was injected into the GC. For GC analysis a Hewlett Packard HP 6850 gas chromatograph was coupled with a flame ionization detector (FID). The column was a Zebron ZB-5 capillary column (30 m×0.25 mm×1 μm). Injector and detector temperatures were 250° C. and 280° C., respectively. The oven temperature was kept at 40° C. for 1 min and programmed at a rate of 4° C./min to 250° C., the final step lasting 20 min.

The results showed that addition of polyphenols significantly decreased the amount of methylglyoxal in stored carbonated high fructose corn syrup containing solutions (Table 4).

TABLE 4
MGO Content in Carbonated High
Fructose Corn Syrup Solutions

| | | | | Decrease of | | | % relative | | |
|---|---|---|---|---|---|---|---|---|---|
| | | | | MGO related to | | | decrease of | | |
| | MGO (μg/L) | | | control (μg/L) | | | MGO to control | | |
| Sample | Week 1 | Week 2 | Week 3 | Week 1 | Week 2 | Week 3 | Week 1 | Week 2 | Week 3 |
| Control | 744.37 | 780.51 | 914.80 | — | — | — | — | — | — |
| GE | 749.39 | 757.59 | 814.84 | — | 22.92 | 99.96 | — | 2.9% | 10.9% |
| 0.05% | | | | | | | | | |
| GE 0.1% | 762.30 | 736.05 | 720.75 | — | 44.46 | 194.05 | — | 5.7% | 21.2% |
| GE | 717.80 | 663.32 | 564.91 | 26.57 | 117.19 | 349.89 | 3.6% | 15% | 38.2% |
| 0.15% | | | | | | | | | |

GE: green tea extract

### 7.5 Example 5

### Reducing Reactive Carbonyl Species in Cola with EGCG

This example demonstrates that reactive carbonyl species found in commercially-available colas are reduced with EGCG.

Amounts of EGCG were added to batches of commercially-available regular cola in final concentrations of 0.12% EGCG or 0.24% EGCG. Batches were stored at room temperature for one, two, three or four weeks, and the concentrations of MGO in the batches were tested using the derivatization reagent 1,2-diaminobenzene following the procedure described in the previous example. Results are provided in Table 5.

TABLE 5
MGO Content in Regular Cola

| | MGO for one | MGO for two | MGO for three | MGO for four |
|---|---|---|---|---|
| | week | weeks | Weeks | Weeks |
| Sample | (μg/100 mL) | (μg/100 mL) | (μg/100 mL) | (μg/100 mL) |
| Control 0% EGCG | 333.5 ± 26.8 | 357.4 ± 26.8 | 386.5 ± 15.8 | 434.5 ± 14.7 |
| 0.12% EGCG | 149.1 ± 19.0 | 197.4 ± 8.9 | 187.4 ± 20.7 | 172.6 ± 13.1 |
| 0.24% EGCG | 161.7 ± 15.1 | 190.2 ± 14.5 | 164.5 ± 17.9 | 147.8 ± 11.6 |

Results shown in Table 5 indicate that MGO concentrations were reduced in all batches of cola in which EGCG was added.

All references cited herein are incorporated herein by reference in their entirety and for all purposes to the same extent as if each individual publication or patent or patent application was specifically and individually indicated to be incorporated by reference in it entirety for all purposes.

Many modifications and variations of this invention can be made without departing from its spirit and scope, as will be apparent to those skilled in the art. The specific embodiments described herein are offered by way of example only, and the invention is to be limited only by the terms of the appended claims along with the full scope of equivalents to which such claims are entitled.

1. A method for reducing the concentration of a reactive carbonyl species in a food, comprising: contacting the food with a scavenging molecule, thereby reducing the concentration of the reactive carbonyl species.

2. The method of claim 1, wherein the scavenging molecule consists essentially of a substantially pure compound.

3. The method of claim 1 further comprising thermally processing the food.

4. The method of claim 3, wherein the food is contacted with the scavenging molecule prior to thermally processing the food.

5. The method of claim 3, wherein the food is contacted with the scavenging molecule after thermally processing the food.

6. The method of claim 3 further comprising packaging the food.

7. The method of claim 1, wherein the food is for human consumption.

8. The method of claim 1, wherein the scavenging molecule is a polyphenol.

9. The method of claim 8, wherein the polyphenol is selected from the group consisting of gallic acid and pyrogallol.

10. The method of claim 8, wherein the polyphenol is a flavonoid.

11. The method of claim 10, wherein the flavonoid is selected from the group consisting of quercitin, kaempferol, rutin and luteolin.

12. The method of claim 10, wherein the flavonoid is a green tea catechin.

13. The method of claim 12, wherein the green tea catechin is selected from the group consisting of epicatechin, epicatechin gallate, epigallocatechin, and epigallocatechin gallate.

14. The method of claim 10, wherein the flavonoid is a black tea theaflavin.

15. The method of claim 14, wherein the black tea theaflavin is selected from the group consisting of theaflavin, theaflavin-mono-gallate and theaflavin-di-gallate.

16. The method of claim 1, wherein the scavenging molecule consists essentially of a polyphenol.

17. The method of claim 1, wherein the food is a beverage.

18. The method of claim 17, further comprising packaging the beverage in a bottle or can.

19. The method of claim 17, wherein the beverage is a still fruit drink, a carbonated soft drink, or a health drink.

20. The method of claim 17, wherein the pH of the beverage ranges from about 2.0 to about 6.0.

21. The method of claim 17, wherein the beverage comprises a concentration of phosphate ion that is greater than about 0.50 mg/100 mL beverage and less than about 5.00 mg/100 mL beverage.

22. The method of claim 17, wherein the beverage comprises a concentration of the reactive carbonyl species that is greater than about 3 μg/100 mL beverage prior to being contacted with the scavenging molecule.

23. The method of claim 1, wherein the concentration of the reactive carbonyl species in the manufactured food product is reduced by about 25% to about 100% after contact with the scavenging molecule.

24. The method of claim 1, wherein the reactive carbonyl species is a dicarbonyl compound.

25. The method of claim 24, wherein the dicarbonyl compound is selected from the group consisting of glyoxal, methylglyoxal and 3-deoxyglucosome.

26. A food product produced by the method of claim 1, wherein the concentration of the scavenging molecule comprises from about 0.01 to about 10 weight percent of the food product.

27. A method for reducing the concentration of a reactive carbonyl species in a subject, the method comprising administering to the subject an oral delivery form of a composition consisting essentially of a scavenging molecule wherein the composition is administered between about one hour before to about one hour after a food is consumed by the subject.

28. The method of claim 27, wherein the subject is human.

29. The method of claim 27, wherein the oral delivery form of the composition is selected from the group consisting of a concentrate, liquid, dried powder, soft gel, solution, suspension, emulsion, capsule, pellet, pill, food additive, and beverage additive.

30. (canceled)

31. (canceled)

32. (canceled)

33. The method of claim 27, wherein the amount of the scavenging molecule ranges from about 0.1 to about 500 mg.

34. The method of claim 27, wherein the scavenging molecule is selected from the group consisting of epicatechin, epicatechin gallate, epigallocatechin, and epigallocatechin gallate.

35. The method of claim 27, wherein the scavenging molecule is selected from the group consisting of theaflavin, theaflavin-mono-gallate and theaflavin-di-gallate.

36. The method of claim 27, wherein the scavenging molecule is orally administered in the form of a food composition comprising green tea catechin, black tea theaflavin, or a mixture thereof in an amount from about 0.01 to about 10 weight percent.
